(19) United States
(12) Patent Application Publication
(10) Pub. No.: US 2026/0095064 A1
(43) Pub. Date: Apr. 2, 2026

(54) CHARGING DEVICE

(71) Applicant: Anker Innovations Technology Co., Ltd., CHANGSHA (CN)

(72) Inventors: Zhifeng ZHONG, SHENZHEN (CN); Songya CHEN, SHENZHEN (CN); Yue ZHAO, SHENZHEN (CN); Jin WANG, SHENZHEN (CN)

(73) Assignee: Anker Innovations Technology Co., Ltd., CHANGSHA (CN)

(21) Appl. No.: 19/344,092

(22) Filed: Sep. 29, 2025

(30) Foreign Application Priority Data
Sep. 30, 2024 (CN) 202422408862.X
Sep. 30, 2024 (CN) 202422410214.8
Sep. 30, 2024 (CN) 202422414495.4

(51) Int. Cl. H02J 50/00; F21V 33/00; H02J 7/00; H02J 50/10

(52) U.S. Cl. CPC H02J 50/005; F21V 33/0004; H02J 7/70; H02J 50/10

(57) ABSTRACT

A charging device, including a base, a rotatable body, and a hover assembly. The base includes a seat body and a first arm protruding from the seat body along a first direction; where the first arm is arranged with a first rotatable portion extending along a second direction, and the first direction and the second direction are set at an angle. The first rotatable portion penetrates the rotatable body and is rotatably connected to the rotatable body, and the rotatable body is configured to support an external device and adjust an angle of the charging device. The hover assembly is configured to enable the rotatable body to support the external device to hover at a preset angle.

### CROSS-REFERENCE TO RELATED APPLICATIONS

The present application claims priority of Chinese Patent Application No. 202422410214.8, filed on Sep. 30, 2024, No. 202422408862.X, filed on Sep. 30, 2024, and No. 202422414495.4, filed on Sep. 30, 2024, the entire contents of which are hereby incorporated by reference in their entirety.

### TECHNICAL FIELD

The present disclosure relates to the technical field of charging devices, and more specifically, to a charging device.

### BACKGROUND

Wireless charging technology has made significant progress in recent years, and an increasing number of devices supporting wireless charging have emerged on the market, such as smartphones, smartwatches, etc. As part of smart homes, wireless charging ambient lights can provide a multifunctional user experience, meeting consumers' demands for smart home products. However, most wireless charging ambient lights currently available on the market have fixed angles and cannot be adjusted. When a user places his/her phone on the wireless charger for charging, the viewing angle of the phone cannot be adjusted, thereby affecting the user's screen viewing experience.

### SUMMARY OF THE DISCLOSURE

The present disclosure provides a charging device, including a base, a rotatable body, and a hover assembly. The base includes a seat body and a first arm protruding from the seat body along a first direction; where the first arm is arranged with a first rotatable portion extending along a second direction, and the first direction and the second direction are set at an angle. The first rotatable portion penetrates the rotatable body and is rotatably connected to the rotatable body, and the rotatable body is configured to support an external device and adjust an angle of the charging device. The hover assembly is configured to enable the rotatable body to support the external device to hover at a preset angle.

The present disclosure further provides a charging device, including: a base; a rotatable body, disposed on the base and rotatably connected to the base; wherein the rotatable body is configured to support an external device and adjust an angle of the charging device; a wireless charging module, disposed on the rotatable body and configured to wirelessly charge the external device; and a light-emitting module, disposed inside the rotatable body; wherein a light-transmitting portion is arranged on the rotatable body at a position corresponding to the light-emitting module.

The present disclosure further provides a charging device, including: a base, including an upper seat, a lower seat, and a first support arm; wherein the upper seat is disposed on the lower seat, and the first support arm is disposed on the upper seat; a rotatable body, rotatably connected to the first support arm around a first axis; wherein the rotatable body is configured to support an external device and adjust an angle of the charging device; a wireless charging module, disposed on the rotatable body; and a light-emitting module, disposed on the rotatable body; wherein at least one of the following is satisfied: the first support arm is rotatably connected to the upper seat around a second axis, and the second axis is arranged at an angle to the first axis; and the upper seat is rotatably connected to the lower seat around a third axis, and the third axis is arranged at an angle to the first axis.

### BRIEF DESCRIPTION OF THE DRAWINGS

To more clearly illustrate the technical solutions in the embodiments of the present disclosure, the accompanying drawings used in the embodiments will be briefly described below. Obviously, the drawings in the following description are merely some embodiments of the present disclosure. For those skilled in the art, other drawings may be derived from these accompanying drawings without creative effort.

FIG. 1 is a structural schematic view of a charging device according to some embodiments of the present disclosure.

FIG. 2 is a structural schematic view of a charging device according to other embodiments of the present disclosure.

FIG. 3 is a structural schematic view of a base according to some embodiments of the present disclosure.

FIG. 4 is an exploded structural schematic view of a charging device according to some embodiments of the present disclosure.

FIG. 5 is a structural schematic view of a base and a hover assembly according to some embodiments of the present disclosure.

FIG. 6 is an exploded structural schematic view of a charging device according to other embodiments of the present disclosure.

FIG. 7 is an exploded structural schematic view of a charging device according to further other embodiments of the present disclosure.

FIG. 8 is a structural schematic view of a base and a second pressing buckle according to some embodiments of the present disclosure.

FIG. 9 is a structural schematic view of a base and a second pressing buckle according to some embodiments of the present disclosure.

FIG. 10 is an internal structural schematic view of a base according to some embodiments of the present disclosure.

FIG. 11 is a top view of a charging device according to some embodiments of the present disclosure.

FIG. 12 is a cross-sectional view taken at line AA in FIG. 11 according to some embodiments.

FIG. 13 is a cross-sectional view taken at line AA in FIG. 11 according to other embodiments.

FIG. 14 is an exploded structural schematic view of a charging device according to yet others embodiments of the present disclosure.

FIG. 15 is an exploded structural schematic view of a charging device according to still others embodiments of the present disclosure.

### DETAILED DESCRIPTION

To make the objectives, technical solutions, and advantages of the present disclosure clearer, the following further describes the present disclosure in detail with reference to the accompanying drawings and embodiments. It should be understood that the specific embodiments described herein are merely intended to explain the present disclosure and are not intended to limit the present disclosure.

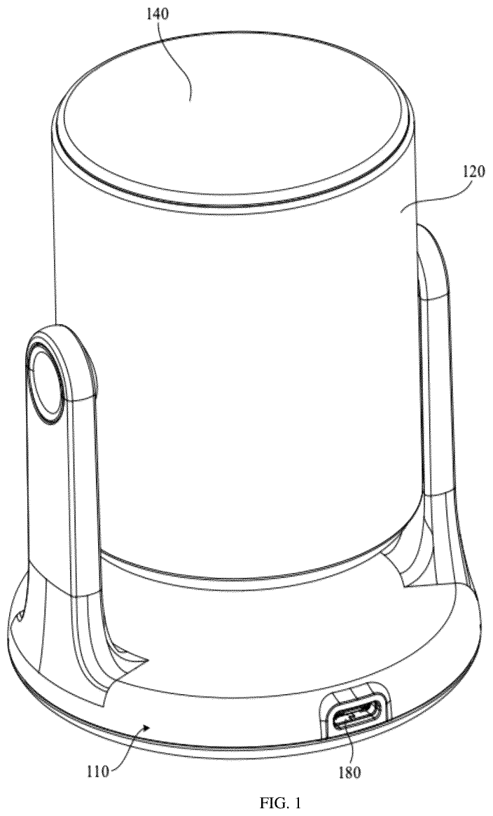

As shown in FIG. 1, the present disclosure provides a charging device 100. The charging device 100 is configured to charge an external device, which may exemplarily be a mobile phone, tablet computer, wireless earphones, smartwatch, etc.

The charging device 100 includes a base 110 and a rotatable body 120.

The base 110 is configured to support the rotatable body 120. The rotatable body 120 is hingedly connected to the base 110. The rotation axis of the rotatable body 120 may be parallel to the horizontal direction, or parallel to the vertical direction, or may be between the horizontal and vertical directions, which is not limited herein.

The rotatable body 120 can support the external device. When the rotatable body 120 rotates, the angle of the charging device 100 changes. The external device rotates synchronously with the rotatable body 120, thereby adjusting the angle of the external device to facilitate the user in selecting a suitable angle for viewing the external device.

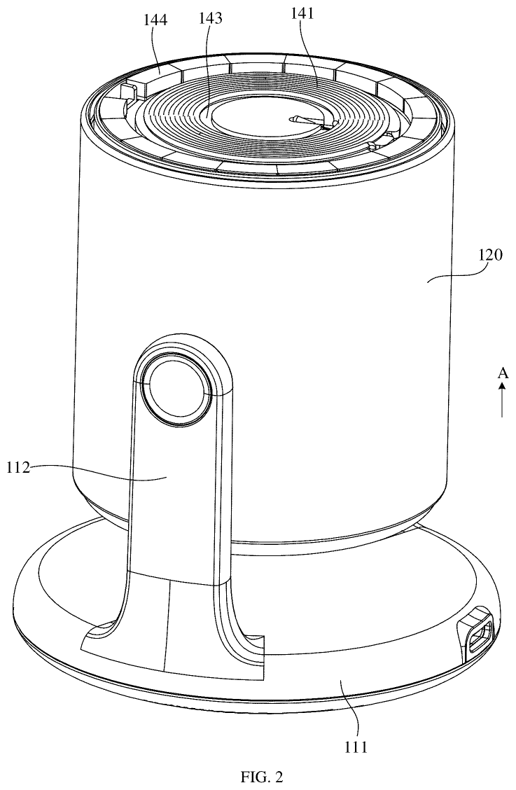

As shown in FIG. 2, in some embodiments, the base 110 includes a seat body 111 and a first arm 112. The shape of the seat body 111 may exemplarily be plate-like, such that the center of gravity of the base 110 is relatively low, and the base 110 is relatively stable when placed on a tabletop. The shape of the first arm 112 may exemplarily be rod-like, thereby saving material.

The first arm 112 may protrude from the seat body 111 along a first direction A. The first direction A may exemplarily be a direction perpendicular to the base 110 or a direction inclined to the base 110.

In some embodiments, the rotatable body 120 is hingedly connected to the first arm 112 and is spaced apart from the seat body 111. That is, the first arm 112 raises the rotatable body 120, such that the rotatable body 120 does not collide with the base 110 during rotation, thereby offering the rotatable body 120 a large range of rotation.

In some embodiments, an end of the first arm 112 away from the base 110 is hingedly connected to the rotatable body 120, thereby effectively utilizing the length of the first arm 112 and allowing the first arm 112 to be relatively short.

In some embodiments, the outer contour shape of the rotatable body 120 may be a regular shape, making the rotatable body 120 easy to design and manufacture, with good space utilization and aesthetics. In some embodiments, the outer contour shape of the rotatable body 120 may be cylindrical, frustoconical, cuboid, cube, spherical, etc.

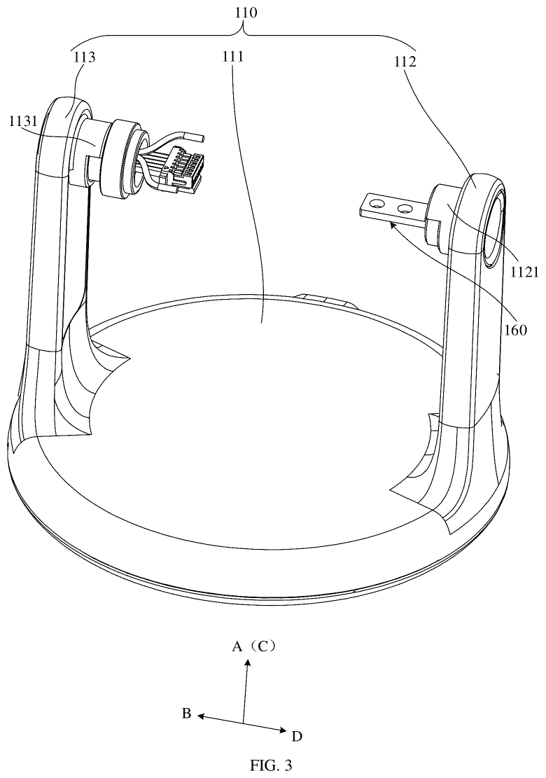

As shown in FIG. 3, in some embodiments, the first arm 112 is arranged with a first rotatable portion 1121 extending along a second direction B. The first rotatable portion 1121 is hingedly connected to the rotatable body 120. The first direction A and the second direction B are set at an angle, that is, they are not parallel, and the angle between the first direction A and the second direction B is greater than 0 degrees and less than or equal to 90 degrees.

In some embodiments, the first rotatable portion 1121 penetrates the rotatable body 120 and is rotatably connected to the rotatable body 120, such that the rotatable body 120 has two utilizable ends.

Taking the example where the outer contour shape of the rotatable body 120 is cylindrical, the rotatable body 120 has two opposite end faces and a side surface connecting the two end faces. The first rotatable portion 1121 penetrates the side surface of the rotatable body 120. It is understandable that if the first rotatable portion 1121 is arranged on one of the end faces of the rotatable body 120, it might be difficult to set other functional modules on this end face. In the embodiments, the first rotatable portion 1121 penetrates the side surface of the rotatable body 120, such that both the end faces of the rotatable body 120 can be arranged with functional modules, and both the functional modules can follow the rotation of the rotatable body 120 to adjust their angles.

As shown in FIG. 3, in some embodiments, the charging device 100 further includes a hover assembly 160. The hover assembly 160 can generate damping, that is, the hover assembly 160 is configured to provide rotational torque for the rotatable body 120 relative to the first rotatable portion 1121, such that the rotatable body 120 can support the external device to hover at a preset angle. Exemplarily, based on the weight of common external devices, a first threshold is determined. The first threshold is the torque moment of common external devices on a rotatable device. The torque moment of the hover assembly 160 is set to be greater than or equal to the first threshold, such that the gravity of the external device itself cannot overcome the torque of the hover assembly 160, and the external device can hover at the preset angle. Of course, the first threshold should not be too large; otherwise, the user would find it difficult to rotate the rotatable body 120.

In some embodiments, the maximum rotation angle of the rotatable body 120 is a preset angle, which may be set according to actual needs. Exemplarily, the rotatable body 120 is cylindrical. The preset angle is greater than 0 degrees and less than or equal to 360 degrees. Specifically, the preset angle may be 120 degrees, such that the tilt angle of the rotatable body 120 can cover daily use scenarios, avoiding collisions between the external device and the seat body 111 or the first arm 112 due to excessive rotation angle. Alternatively, the preset angle may be 360 degrees, giving the rotatable body 120 a larger range of rotation. Since the rotation amplitude of the rotatable body 120 is relatively large, a mobile phone or other external devices can be rotated from facing forward to facing backward, or from facing left to facing right, allowing for a large adjustment range when adjusting the angle.

In some embodiments, the charging device 100 further includes a driving member. The output end of the driving member is fixedly connected to the rotatable body 120, and the driving member drives the rotatable body 120 to rotate, eliminating the need for the user to manually adjust the angle of the rotatable body 120, thereby making the user more comfortable when using the charging device 100. The driving member may exemplarily be a motor. Since the motor has self-locking characteristics, it can further be configured to achieve hovering of the rotatable body 120.

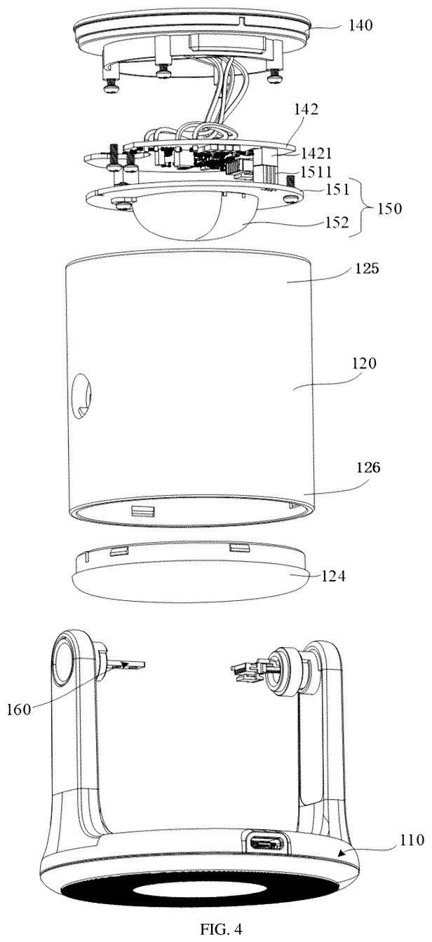

As shown in FIG. 4, in some embodiments, the hover assembly 160 is disposed between the rotatable body 120 and the first rotatable portion 1121 to prevent the rotatable body 120 from rotating relative to the first rotatable portion 1121. When no external force is applied, the rotatable body 120 can remain hovering, thereby maintaining a fixed angle. When an external force is applied, the rotatable body 120 can rotate, allowing the adjustment of the support angle of the rotatable body 120 for the external device. In other embodiments, the hover assembly 160 may be provided disposed the rotatable body 120 and the first arm 112, or between the rotatable body 120 and the seat body 111.

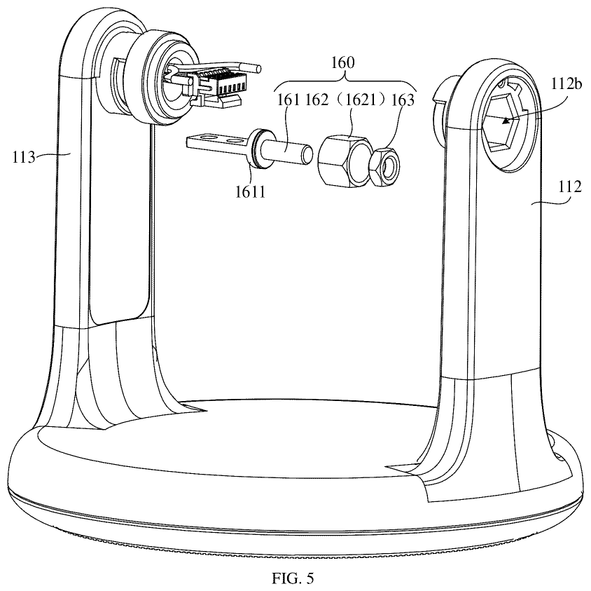

As shown in FIG. 5, in some embodiments, the hover assembly 160 includes a first connecting member 161, a second connecting member 162, and an adjusting member 163.

The first connecting member 161 and the second connecting member 162 are rotatably connected and have damping cooperation. The adjusting member 163 abuts against the second connecting member 162 and follows the rotation of the first connecting member 161, such that when the first connecting member 161 rotates relative to the second connecting member 162, a certain torque (i.e., damping) exists. The hover assembly 160 can provide torque while also serving as a rotating component between the first arm 112 and the rotatable body 120, thereby reducing wear between the first arm 112 and the rotatable body 120.

The adjusting member 163 is connected to both the first connecting member 161 and the second connecting member 162. The adjusting member 163 is configured to adjust the force between the adjusting member 163 and the second connecting member 162, thereby changing the torque of the hover assembly 160. The user can adjust the torque of the hover assembly 160 according to his/her own needs. When the torque of the hover assembly 160 is relatively large, the rotatable body 120 is less likely to rotate, thus being able to carry heavier external devices; when the torque of the hover assembly 160 is relatively small, the user saves effort when driving the rotation of the rotatable body 120, and the rotatable body 120 is suitable for carrying lighter external devices. The torque of the hover assembly 160 in the embodiments of the present disclosure is adjustable, thereby meeting the usage habits of different users.

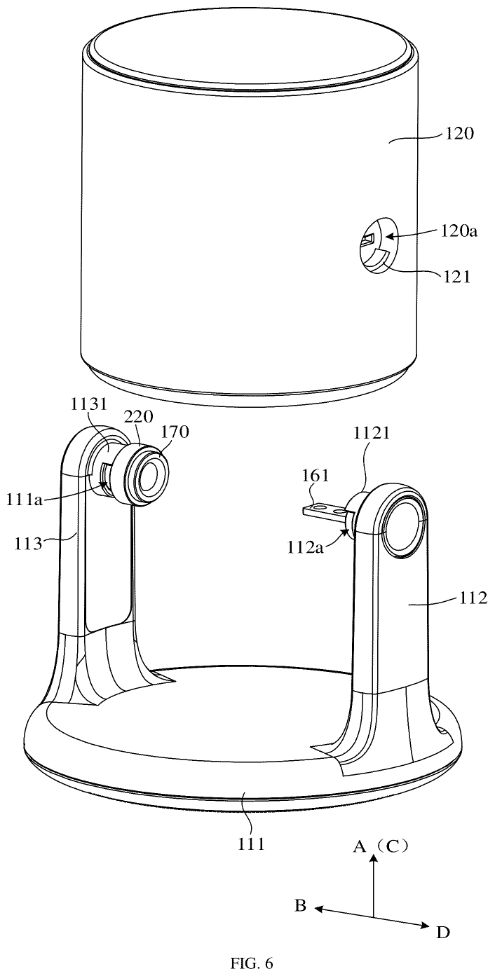

Exemplarily, as shown in FIGS. 5 and 6, an end of the first connecting member 161 is fixedly connected to the first rotatable portion 1121, and the other end of the first connecting member 161 is arranged with an external thread. The middle part of the first connecting member 161 is arranged with an abutting portion 1611. The adjusting member 163 is arranged with an internal thread. The internal thread of the adjusting member 163 is screwed onto the external thread of the first connecting member 161. For example, the adjusting member 163 may be a nut.

The second connecting member 162 includes a shaft sleeve 1621 and a torque shim (not shown) disposed inside the shaft sleeve 1621. The shaft sleeve 1621 and the torque shim are both sleeved on the first connecting member 161 and disposed between the abutting portion 1611 and the adjusting member 163. The shaft sleeve 1621 is fixed to the first arm 112. The first connecting member 161 can rotate relative to the shaft sleeve 1621, and the torque shim follows the rotation of the first connecting member 161. Torque is generated between the torque shim and the shaft sleeve 1621. The adjusting member 163 can rotate relative to the first connecting member 161 to adjust the pressing force between the torque shim and the shaft sleeve 1621, thereby adjusting the torque between the torque shim and the shaft sleeve 1621. The greater the force between the torque shim and the shaft sleeve 1621, the greater the torque of the hover assembly 160; the smaller the force, the smaller the torque.

In other embodiments, the hover assembly 160 may only include a rubber ring. The rubber ring is disposed between the first rotatable portion 1121 and the rotatable body 120. The rubber ring is configured to increase the rotational resistance between the first arm 112 and the rotatable body 120, thereby providing torque and making the structure of the charging device 100 relatively simple.

Of course, the charging device 100 may not include the hover assembly 160. The first rotatable portion 1121 and the rotatable body 120 are hingedly connected by an interference fit, and the friction between the first rotatable portion 1121 and the rotatable body 120 provides torque, which further simplifies the structure of the charging device 100.

In some embodiments, a side of the first arm 112 away from the first rotatable portion 1121 defines a mounting groove 112b. The second connecting member 162 is fixedly arranged in the mounting groove 112b. The bottom wall of the mounting groove 112b restricts the movement of the second connecting member 162 along the first direction A. The side wall of the mounting groove 112b restricts the rotation of the second connecting member 162 along the rotation direction of the rotatable body 120. Exemplarily, the mounting groove 112b may be a hexagonal groove, and the shape of the second connecting member 162 is also hexagonal, such that the mounting groove 112b can prevent the second connecting member 162 from rotating. Of course, the mounting groove 112b may be a triangular groove, quadrangular groove, or other non-circular groove, and the second connecting member 162 should have a shape matching the mounting groove 112b.

In some embodiments, the hover assembly 160 includes a first pressing buckle and a first bearing. The first pressing buckle is fixedly connected to the first rotatable portion 1121. The first bearing is fixedly connected to the rotatable body 120. The first bearing is sleeved on the first pressing buckle and is rotatably connected to it. By providing the first pressing buckle and the first bearing, friction between the first rotatable portion 1121 and the rotatable body 120 may be reduced, thereby extending the service life.

In some embodiments, damping oil may be provided between the first pressing buckle and the first bearing, such that there is rotational torque between the first pressing buckle and the first bearing to achieve a hovering effect. Alternatively, the first pressing buckle and the first bearing may have an interference fit to achieve the hovering effect.

As shown in FIG. 3, in some embodiments, the charging device 100 further includes a second arm 113. The shape of the second arm 113 may exemplarily be rod-like, thereby saving material. The second arm 113 protrudes from the seat body 111 along a third direction C. The third direction C may be the same as or different from the first direction A. The third direction C may exemplarily be a direction perpendicular to the base 110 or a direction inclined to the base 110.

The second arm 113 is spaced apart from the first arm 112. The rotatable body 120 is hingedly connected to both the first arm 112 and the second arm 113. That is, the rotation axis of the rotatable body 120 with the first arm 112 is collinear with the rotation axis of the rotatable body 120 with the second arm 113. By providing the second arm 113, both sides of the rotatable body 120 are supported, the force on both sides of the rotatable body 120 is thus relatively even, such that the connection strength between the rotatable body 120 and the base 110 may be increased, and the rotatable body 120 may be able to carry heavier external devices and more stable during rotation.

As shown in FIG. 3, the second arm 113 extends along a fourth direction D to form a second rotatable portion 1131. The second rotatable portion 1131 is hingedly connected to the rotatable body 120. The fourth direction D is opposite to the second direction B. That is, the second rotatable portion 1131 and the first rotatable portion 1121 are arranged opposite to each other. The rotatable body 120 is disposed between the second rotatable portion 1131 and the first rotatable portion 1121. The second rotatable portion 1131 and the first rotatable portion 1121 can jointly limit the position of the rotatable body 120, thereby preventing the rotatable body 120 from falling off between the first arm 112 and the second arm 113.

In some embodiments, the second rotatable portion 1131 penetrates the rotatable body 120. The rotatable body 120 is disposed between the first rotatable portion 1121 and the second rotatable portion 1131 and is hingedly connected to both the first rotatable portion 1121 and the second rotatable portion 1131.

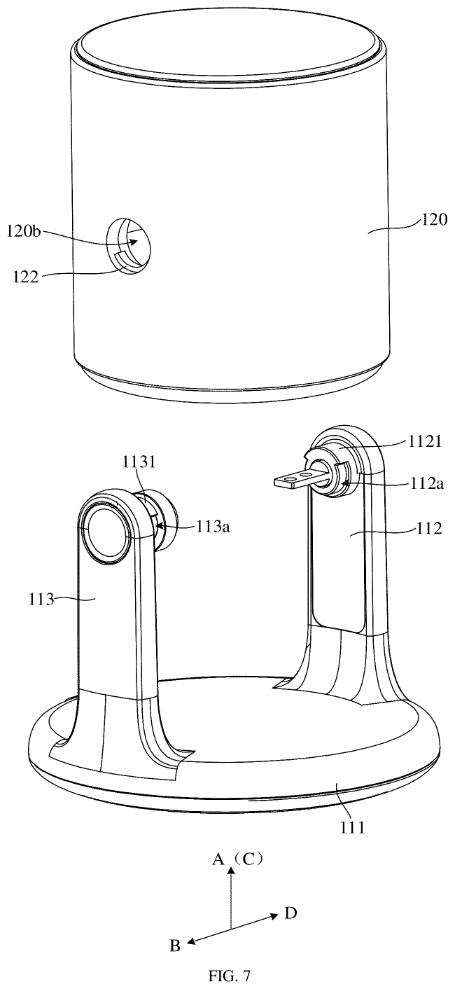

As shown in FIGS. 6-7, in some embodiments, the rotatable body 120 defines a first rotating hole 120a and a second rotating hole 120b that are coaxial. The first rotatable portion 1121 is rotatably arranged in the first rotating hole 120a. The second rotatable portion 1131 is rotatably arranged in the second rotating hole 120b. In other embodiments, the positions of the rotating holes and the rotatable portions may be swapped. That is, the first rotating hole 120a may be arranged on the first arm 112, and the second rotating hole 120b may be arranged on the second arm 113. The first rotatable portion 1121 and the second rotatable portion 1131 may both be arranged on the rotatable body 120.

Generally, compared to the first rotating hole 120a, the first rotatable portion 1121 is more prone to damage. Similarly, compared to the second rotating hole 120b, the second rotatable portion 1131 is more prone to damage. In the embodiments, the first rotatable portion 1121 is arranged on the first arm 112, and the second rotatable portion 1131 is arranged on the second arm 113. When the first rotatable portion 1121 or the second rotatable portion 1131 is damaged, since the light-emitting module 150 and the wireless charging module 140 are both arranged on the rotatable body 120, replacing the first arm 112 or the second arm 113 may be simpler and less costly than replacing the rotatable body 120.

As shown in FIG. 6, in some embodiments, the first connecting member 161 may pass through the first rotating hole 120a and extend into the interior of the rotatable body 120 to be connected with the internal structure of the rotatable body 120, thereby enhancing the connection strength between the second connecting member 162 and the rotatable body 120. In some embodiments, the first rotating hole 120a may be a blind hole. The bottom wall of the first rotating hole 120a defines a limiting hole. An end of the first connecting member 161 away from the adjusting member 163 passes through the limiting hole and extends into the interior of the rotatable body 120. The shape of the limiting hole may be rectangular. An end of the second connecting member 162 away from the adjusting member 163 may be shaped like a sheet matching the limiting hole, such that the second connecting member 162 and the rotatable body 120 can have limiting cooperation in the rotation direction, and the second connecting member 162 can rotate synchronously with the rotatable body 120.

As shown in FIG. 6, in some embodiments, one of the first rotatable portion 1121 and the hole wall of the first rotating hole 120a is arranged with a first limiting protrusion 121, and the other of the first rotatable portion 1121 and the hole wall of the first rotating hole 120a defines a first limiting groove 112a. The first limiting protrusion 121 is slidably arranged in the first limiting groove 112a. The first limiting protrusion 121 and the first limiting groove 112a cooperate to limit the rotation angle of the rotatable body 120 relative to the first arm 112.

Exemplarily, the first rotatable portion 1121 defines the first limiting groove 112a, and the first rotating hole 120a is arranged with the first limiting protrusion 121. The shape of the first limiting groove 112a is arc-shaped. When the rotatable body 120 rotates, the first limiting protrusion 121 rotates synchronously and slides within the first limiting groove 112a. When the first limiting protrusion 121 abuts against an end of the first limiting groove 112a, the first limiting protrusion 121 cannot continue to rotate, thereby limiting the rotation of the rotatable body 120. It is understandable that mobile phones and other external devices are relatively large. When a mobile phone is fixed on the rotatable body 120 and rotates with it, the mobile phone may collide with the base 110, the first arm 112, or the second arm 113. By providing the first limiting protrusion 121, the rotation angle of the rotatable body 120 may be limited, thereby preventing larger external devices like mobile phones from colliding with the base 110, the first arm 112, or the second arm 113, and thus improving safety.

As shown in FIG. 6, in some embodiments, in the rotation direction of the rotatable body 120, the first limiting protrusion 121 abuts against both side walls of the first limiting groove 112a to restrict the rotation of the rotatable body 120. The difference in size between the first limiting protrusion 121 and the first limiting groove 112a in the rotation direction of the rotatable body 120 defines the rotation range of the rotatable body 120.

As shown in FIG. 7, in some embodiments, one of the second rotatable portion 1131 and the hole wall of the second rotating hole 120b is arranged with a second limiting protrusion 122, and the other of the second rotatable portion 1131 and the hole wall of the second rotating hole 120b defines a second limiting groove 113a. The second limiting protrusion 122 is slidably arranged in the second limiting groove 113a. The second limiting protrusion 122 and the second limiting groove 113a cooperate to limit the rotation angle of the rotatable body 120 relative to the second arm 113.

Exemplarily, the second rotatable portion 1131 defines the second limiting groove 113a, and the second rotating hole 120b is arranged with the second limiting protrusion 122. The shape of the second limiting groove 113a is arc-shaped. When the rotatable body 120 rotates, the second limiting protrusion 122 rotates synchronously and slides within the second limiting groove 113a. When the second limiting protrusion 122 abuts against an end of the second limiting groove 113a, the second limiting protrusion 122 cannot continue to rotate, thereby limiting the rotation of the rotatable body 120. It is understandable that mobile phones and other external devices are relatively large. When a mobile phone is fixed on the rotatable body 120 and rotates with it, the mobile phone may collide with the base 110, the first arm 112, or the second arm 113. By providing the second limiting protrusion 122, the rotation angle of the rotatable body 120 may be limited, thereby preventing larger external devices like mobile phones from colliding with the base 110, the first arm 112, or the second arm 113, and thus improving safety.

As shown in FIGS. 6-7, in some embodiments, the first limiting protrusion 121, the first limiting groove 112a, the second limiting protrusion 122, and the second limiting groove 113a may be provided simultaneously, such that the first limiting protrusion 121 and the second limiting protrusion 122 can jointly limit the rotatable body 120, thereby enhancing the limiting effect and ensuring that both sides of the rotatable body 120 are subjected to force evenly during limiting.

As shown in FIG. 7, in some embodiments, in the rotation direction of the rotatable body 120, the second limiting protrusion 122 abuts against both side walls of the second limiting groove 113a to restrict the rotation of the rotatable body 120. The difference in size between the second limiting protrusion 122 and the second limiting groove 113a in the rotation direction of the rotatable body 120 defines the rotation range of the rotatable body 120.

In some embodiments, the hole wall of the second rotating hole 120b is arranged with the second limiting protrusion 122. The charging device 100 further includes a second pressing buckle 170 and a second bearing 220. An end of the second pressing buckle 170 is fixedly connected to the second rotatable portion 1131. The other end of the second pressing buckle 170 passes through the second rotating hole 120b and is arranged with a flange 171. The second bearing 220 is fixedly connected to the rotatable body 120. The second bearing 220 is sleeved on the second pressing buckle 170 and rotatably connected to the second pressing buckle 170. The second pressing buckle 170 is disposed between the flange 171 and the second limiting protrusion 122. The flange 171 and the second limiting protrusion 122 jointly limit the position of the second pressing buckle 170, thereby preventing the second pressing buckle 170 from falling off the second bearing 220. The structure of the first pressing buckle and the first bearing mentioned above may refer to the second pressing buckle 170 and the second bearing 220.

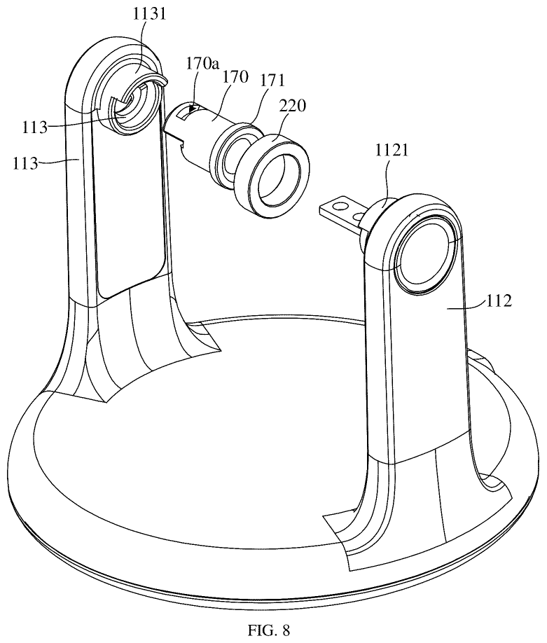

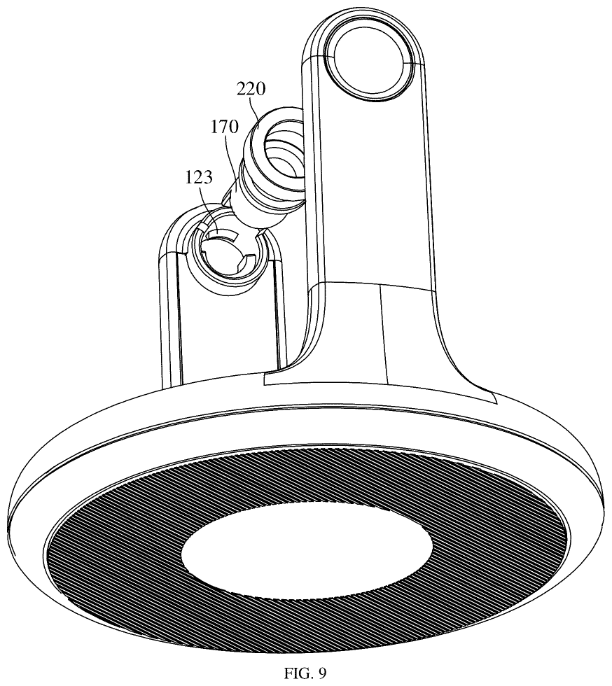

As shown in FIGS. 8-9, in some embodiments, the second rotatable portion 1131 has a hollow structure. The outer wall of the second pressing buckle 170 is attached to the inner wall of the second rotatable portion 1131. One of the outer wall of the second pressing buckle 170 and the inner wall of the second rotatable portion 1131 defines a limiting hole 170a, and the other of the outer wall of the second pressing buckle 170 and the inner wall of the second rotatable portion 1131 is arranged with a third limiting protrusion 123. The limiting hole 170a and the third limiting protrusion 123 cooperate to restrict the movement of the second pressing buckle 170 along the second direction B or the fourth direction D, and to restrict the rotation of the second pressing buckle 170 relative to the second arm 113.

Exemplarily, the outer wall of the second pressing buckle 170 defines the limiting hole 170a, and the inner wall of the second rotatable portion 1131 is arranged with the third limiting protrusion 123. When assembling the second pressing buckle 170 to the second arm 113, the second pressing buckle 170 is directly inserted into the second rotatable portion 1131 until the third limiting protrusion 123 engages with the limiting hole 170a, thereby completing the assembly quickly and conveniently. In this way, no additional components are needed to fix the second pressing buckle 170 to the second arm 113, which makes the structure relatively simple and cost-effective. In some embodiments, the second pressing buckle 170 and the second rotatable portion 1131 have an interference fit, thereby further enhancing the limiting effect.

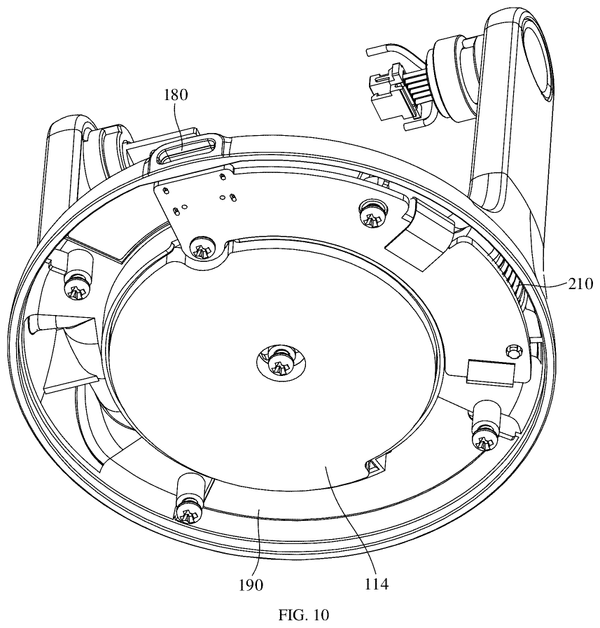

As shown in FIG. 10, in some embodiments, the charging device 100 further includes a counterweight block 114. The counterweight block 114 is disposed inside the seat body 111, thereby further lowering the center of gravity of the base 110 and making the charging device 100 more stable.

As shown in FIG. 1, in some embodiments, the charging device 100 further includes a wireless charging module 140. The wireless charging module 140 is disposed on the rotatable body 120 and is configured to charge external devices.

As shown in FIGS. 2 and 4, the wireless charging module 140 includes a coil 141, a main control board 142, a magnetic isolation sheet 143, and a magnet 144. The main control board 142 is electrically connected to the coil 141 to control the coil 141 to emit electromagnetic signals. A receiving coil in the external device can receive the electromagnetic signals and convert them into current for charging.

The magnetic isolation sheet 143 is disposed between the main control board 142 and the coil 141. The magnetic isolation sheet 143 can reflect the electromagnetic signals, directing them towards the external device, thereby preventing the electromagnetic signals from affecting the main control board 142.

The magnet 144 surrounds the coil 141 and can adsorb with the external devices, thereby ensuring alignment between the external devices and the wireless charging module 140, and thus preventing offset and improving charging efficiency.

As shown in FIG. 4, in some embodiments, the charging device 100 further includes a light-emitting module 150. The light-emitting module 150 is disposed on the rotatable body 120, and the rotatable body 120 has a light-transmitting portion at a corresponding position of the light-emitting module 150. The light-emitting module 150 can illuminate the surrounding environment, functioning as a desk lamp, night light, or ambient light. When using a mobile phone in a dark environment, the light-emitting module 150 can reduce the brightness difference between the phone screen and the surrounding environment, thereby protecting the user's eyes. When the rotatable body 120 rotates, the light-emitting module 150 may follow the rotation, meaning that the angle of the light-emitting module 150 can be adjusted to illuminate different positions, making it convenient to use.

As shown in FIG. 4, in some embodiments, the rotatable body 120 has a first end 125 and a second end 126 that are opposite each other. A wireless charging module 140 is arranged on the first end 125. The charging device 100 further includes a light-emitting module 150 arranged on the second end 126. The wireless charging module 140 and the light-emitting module 150 may be the aforementioned two functional modules. In some embodiments, the rotatable body 120 is hingedly connected to the first arm 112 at a middle position between the first end 125 and the second end 126, such that the first arm 112 may be relatively short, and the force on the first end 125 and the second end 126 of the rotatable body 120 is relatively balanced, resulting in less centrifugal force when the rotatable body 120 rotates.

As shown in FIG. 4, in some embodiments, the light-emitting module 150 is arranged away from the wireless charging module 140, meaning that the light emitted by the light-emitting module 150 shines in a direction away from the wireless charging module 140. Generally, when a mobile phone is placed on the wireless charging module 140 for charging, the mobile phone's screen faces the user. Since the light from the light-emitting module 150 is directed away from the wireless charging module 140, it does not shine directly at the user, thereby avoiding eye irritation. The rotatable body 120 may simultaneously drive the rotation of both the wireless charging module 140 and the light-emitting module 150, thereby simplifying the structure of the charging device 100 and reducing costs.

As shown in FIG. 4, in some embodiments, the light-emitting module 150 includes a light board 151 with multiple LED beads. The LED beads have high brightness, are energy-efficient, and have a long service life. In some embodiments, the light board 151 is arranged with a reflective coating that can reflect light, making the light from the light board 151 more concentrated and brighter.

As shown in FIG. 4, in some embodiments, one of the light board 151 and the main control board 142 is arranged with a plugging portion 1421, and the other of the light board 151 and the main control board 142 is arranged with a cooperating portion 1511. The light board 151 and the main control board 142 are connected through the plugging portion 1421 and the cooperating portion 1511, thereby making assembly convenient. Exemplarily, the plugging portion 1421 may be a pin header, and the cooperating portion 1511 may be a socket header. Or the plugging portion 1421 may be a male cable connector, and the cooperating portion 1511 may be a female cable connector. The main control board 142 is configured to supply power to the light board 151 and drive the LED beads to light up or change color temperature.

As shown in FIG. 4, in some embodiments, the light-emitting module 150 is disposed inside the rotatable body 120. The rotatable body 120 may have a light-gathering effect, making the light emitted by the light-emitting module 150 more concentrated and directional. In some embodiments, the rotatable body 120 further includes a light-transmitting cover 124 on the second end 126. The light-transmitting cover 124 has a light-transmitting portion. The light-emitting module 150 is spaced apart from the light-transmitting cover 124. The light-transmitting cover 124 allows light to pass through, and the light emitted by the light-emitting module 150 can transmit through the light-transmitting cover 124 to the outside of the rotatable body 120. In some embodiments, the light-transmitting cover 124 is semi-transparent and may function to diffuse light evenly.

As shown in FIG. 4, in some embodiments, the light-emitting module 150 further includes a light-diffusing cover 152. The light-diffusing cover 152 covers the light board 151, thereby further diffusing the light.

As shown in FIG. 10, in some embodiments, the charging device 100 further includes an operation module 190. The operation module 190 is disposed on the seat body 111. The seat body 111 is usually stationary, so regardless of the rotation angle of the rotatable body 120, it does not affect the user's operation of the operation module 190. The operation module 190 is electrically connected to the light-emitting module 150 and may be configured to adjust the color temperature of the light-emitting module 150, or its brightness, or both the color temperature and the brightness. The operation module 190 may be touch-sensitive and disposed inside the seat body 111 for protection and longer service life. By touching the surface of the seat body 111, the user can control the light-emitting module 150, making the seat body 111 well-sealed and aesthetically pleasing. Alternatively, the operation module 190 may be button-type or knob-type, which is not limited herein.

In some embodiments, the charging device 100 further includes a rechargeable battery. The rechargeable battery is disposed inside the rotatable body 120 or the seat body 111 and is electrically connected to both the wireless charging module 140 and the light-emitting module 150 to power them. The charging device 100 can provide lighting or charging without an external power source, making it easy for the user to move it around.

As shown in FIG. 10, in some embodiments, the charging device 100 further includes a connecting terminal 180. The connecting terminal 180 is disposed on the seat body 111 and is electrically connected to both the wireless charging module 140 and the light-emitting module 150 to power them.

The connecting terminal 180 is configured to connect a power cable, through which power is supplied to the charging device 100 via the connecting terminal 180. The type of the connecting terminal 180 may exemplarily be a Type-C interface, which is common. The connecting terminal 180 is arranged on the seat body 111. When using the charging device 100, the seat body 111 is usually stationary, so the power cable is also stationary, thereby ensuring stable power supply.

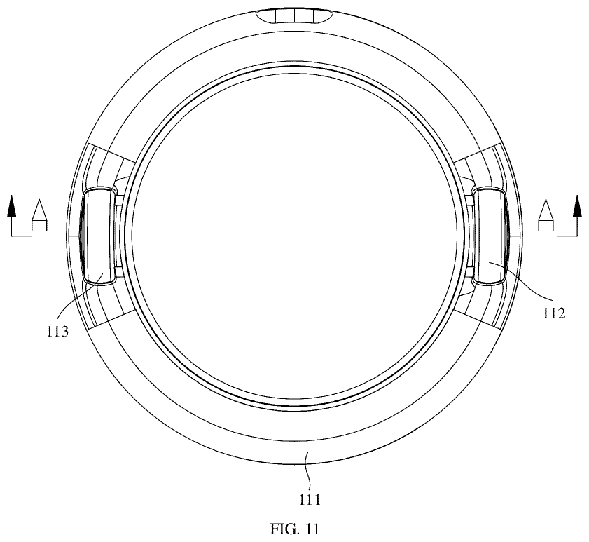

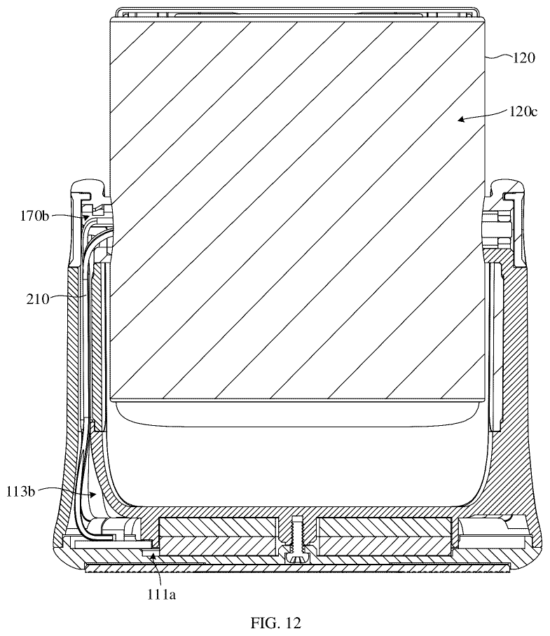

As shown in FIGS. 11 and 12, in some embodiments, the seat body 111 defines a first mounting cavity 111a. The interior of the first arm 112 defines a first wire channel 113b in communication with the first mounting cavity 111a. The rotatable body 120 defines a second mounting cavity 120c. The interior of the second rotatable portion 1131 defines a second wire channel 170b in communication with the first wire channel 113b and the second mounting cavity 120c.

Since the first mounting cavity 111a, the first wire channel 113b, the second wire channel 170b, and the second mounting cavity 120c are communicated in sequence, electrical components in the base 110 can be electrically connected to those in the rotatable body 120 via a wire 210. The wire 210 is not exposed outside the charging device 100, making it safer and more aesthetically pleasing.

Exemplarily, the wire 210 may connect the operation module 190 and the light-emitting module 150. The wire 210 extends from the first mounting cavity 111a through the first wire channel 113b and the second wire channel 170b to the second mounting cavity 120c. The wire 210 can supply power to the operation module 190 and the wireless charging module 140. The operation module 190 can control the light-emitting module 150 via the wire 210.

In some embodiments, the charging device 100 further includes a limiting component. The limiting component is disposed on the rotatable body 120 or the wireless charging module 140 and is configured to limit the position of the external device. The limiting component may be a clamping member on the rotatable body 120, for fixing the external device by clamping. Or, the limiting component may be a magnet 144 that magnetically fixes the external device. The magnet 144 may be integrated into the wireless charging module 140. When the rotatable body 120 rotates, the limiting component and the external device fixed to it can follow the rotation, allowing the external device to adjust its angle. That is, the rotatable body 120 functions as a stand.

The wireless charging module 140 may be arranged corresponding to and facing the limiting component. When the external device is limited by the limiting component, the external device is within an effective charging range of the wireless charging module 140, which can then charge the external device. Exemplarily, the wireless charging module 140 is placed close to the limiting component. When the external device is fixed by the limiting component, the distance between the wireless charging module 140 and the external device is relatively small, thereby enabling charging or improving charging efficiency.

In some embodiments, the first arm 112 is hingedly connected to the seat body 111, and the rotation axis of the first arm 112 is at an angle to the rotation axis of the rotatable body 120, giving the rotatable body 120 rotational degrees of freedom in two directions and making rotation more flexible. That is, the rotatable body 120 rotates around a first axis E, which is parallel to the first direction A. The first arm 112 rotates around a second axis F. The first axis E and the second axis F are at an angle greater than 0 degrees and less than or equal to 90 degrees.

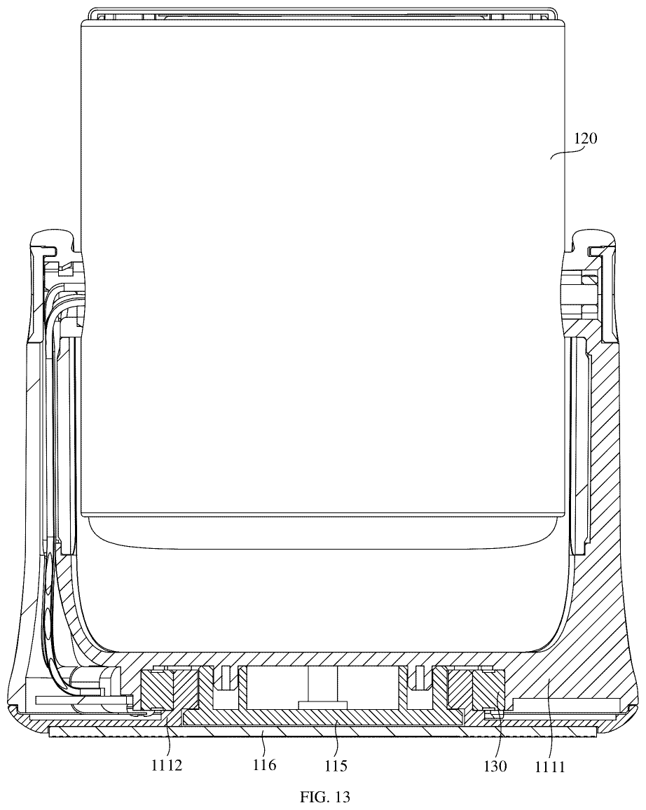

As shown in FIG. 13, in some embodiments, the seat body 111 includes an upper seat 1111 and a lower seat 1112. The upper seat 1111 and the lower seat 1112 are rotatably connected around a third axis G. The third axis G is at an angle to the first axis E, giving the rotatable body 120 rotational degrees of freedom in two directions and making rotation more flexible. The angle between the third axis G and the first axis E is greater than 0 degrees and less than or equal to 90 degrees.

As shown in FIG. 13, in some embodiments, the first arm 112 is hingedly connected to the seat body 111 around the second axis F, and the upper seat 1111 and the lower seat 1112 are rotatably connected around the third axis G. The third axis G is at an angle to both the first axis E and the second axis F, giving the rotatable member 130 rotational degrees of freedom in three directions and making rotation even more flexible. Exemplarily, the rotatable body 120 can swing forward and backward, the first arm 112 can swing left and right, and the base 110 can rotate horizontally, thereby allowing the rotatable body 120 to be oriented arbitrarily in the three-dimensional space. The angle between the third axis G and the second axis F is greater than 0 degrees and less than or equal to 90 degrees.

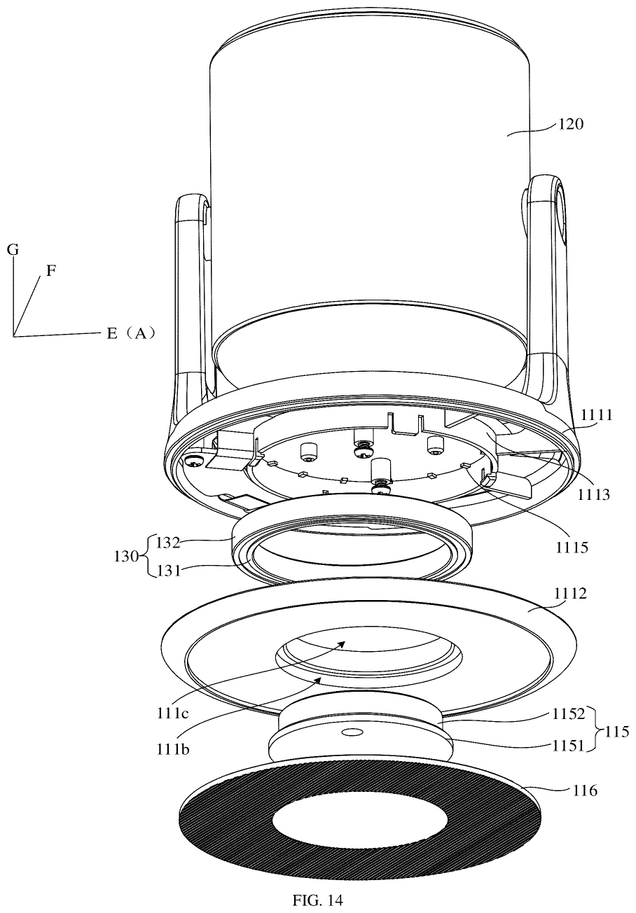

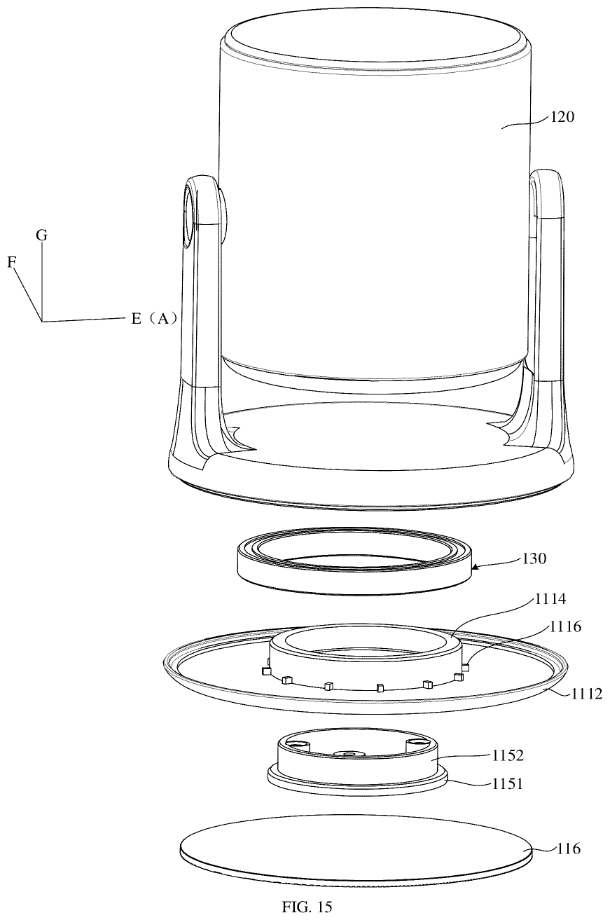

As shown in FIGS. 14 and 15, in some embodiments, the charging device 100 further includes a rotatable member 130. The rotatable member 130 includes an inner ring 131 and an outer ring 132. The inner ring 131 and the outer ring 132 are rotatably connected. One of the lower seat 1112 and the upper seat 1111 is connected to the inner ring 131, and the other of the lower seat 1112 and the upper seat 1111 is connected to the outer ring 132. The lower seat 1112 and the upper seat 1111 are rotatably connected via the rotatable member 130. By providing the rotatable member 130, wear between the inner ring 131 and the outer ring 132 may be reduced, extending their service life, and friction may be reduced, making rotation smoother.

In some embodiments, lubricant or rolling elements may be provided between the inner ring 131 and the outer ring 132 to make rotation even smoother. The rotatable member 130 may exemplarily be a ball bearing.

As shown in FIGS. 14 and 15, in some embodiments, a surface of the upper seat 1111 facing the lower seat 1112 is arranged with a first mounting portion 1113 protruding from the surface. A surface of the lower seat 1112 facing the upper seat 1111 is arranged with a second mounting portion 1114 protruding from the surface. The first mounting portion 1113 is connected to the outer surface of the outer ring 132. The second mounting portion 1114 is connected to the inner surface of the inner ring 131. Exemplarily, the first mounting portion 1113 may be an annular rib to fully abut against the outer surface of the outer ring 132. The second mounting portion 1114 can also be an annular rib to fully abut against the inner surface of the inner ring 131.

As shown in FIGS. 14 and 15, in some embodiments, the surface of the upper seat 1111 facing the lower seat 1112 is further arranged with a first supporting portion 1115 protruding from the surface. The first supporting portion 1115 is connected to the top surface of the outer ring 132. The first supporting portion 1115 can space the inner ring 131 apart from the upper seat 1111, thereby preventing friction between them and further stabilizing the connection between the upper seat 1111 and the outer ring 132. The surface of the lower seat 1112 facing the upper seat 1111 is further arranged with a second supporting portion 1116 protruding from the surface. The second supporting portion 1116 is connected to the bottom surface of the inner ring 131. The second supporting portion 1116 can space the outer ring 132 apart from the lower seat 1112, thereby preventing friction between them and further stabilizing the connection between the lower seat 1112 and the inner ring 131.

As shown in FIGS. 14 and 15, in some embodiments, a surface of the lower seat 1112 away from the upper seat 1111 defines a limiting groove 111b. The bottom wall of the limiting groove 111b defines a through hole 111c. The base 110 further includes a limiting member 115. The limiting member 115 includes a limiting portion 1151 and a connecting portion 1152. The limiting portion 1151 is disposed in the limiting groove 111b and cooperates with it. The connecting portion 1152 passes through the through hole 111c and is connected to the upper seat 1111. The cooperation between the limiting portion 1151 and the limiting groove 111b may prevent the upper seat 1111 and the lower seat 1112 from separating. It should be noted that normally, the upper seat 1111 and the lower seat 1112 are connected via the rotatable member 130, so they won't separate easily. The limiting portion 1151 and the limiting groove 111b are usually spaced apart, so they don't rub against each other, serving as a backup limiting function.

As shown in FIGS. 14 and 15, in some embodiments, the through hole 111c is a circular hole. The outer contour of the connecting portion 1152 is cylindrical. The side surface of the connecting portion 1152 is spaced apart from the side wall of the through hole 111c, such that when the connecting portion 1152 rotates relative to the through hole 111c, it doesn't rub against the side wall. When the upper seat 1111 tilts relative to the lower seat 1112, the connecting portion 1152 abuts against the side wall of the through hole 111c, thereby limiting further tilting and thus protecting the upper seat 1111 and the lower seat 1112.

In some embodiments, the upper seat 1111 and the lower seat 1112 are spaced apart. The base 110 and the lower seat 1112 do not rub against each other when rotating. In some embodiments, the gap between the upper seat 1111 and the lower seat 1112 may be as small as possible to reduce the probability of dust entering the base 110.

In some embodiments, the base 110 further includes an anti-slip pad 116. The anti-slip pad 116 is disposed on the surface of the lower seat 1112 away from the upper seat 1111. The anti-slip pad 116 may prevent slipping, making the base 110 more stable, and further cover the limiting groove, reducing dust entry and improving aesthetics. The limiting member 115 is spaced apart from the anti-slip pad 116 and does not rub against it during rotation.

In the drawings of the embodiments of the present disclosure, the same or similar reference numerals correspond to the same or similar components. In the description of the present disclosure, it should be understood that terms such as “upper”, “lower”, “left”, and “right” indicate orientations or positional relationships based on the drawings, are only for convenience of description, and do not indicate or imply that the referred device or element must have a specific orientation or be constructed and operated in a specific orientation. Therefore, the terms describing positional relationships in the drawings are for illustrative purposes only and cannot be understood as limitations to the present disclosure. Those skilled in the art can understand the specific meanings of these terms according to specific situations.

The above descriptions are only some embodiments of the present disclosure and are not intended to limit the present disclosure. Any modifications, equivalent replacements, and improvements made within the spirit and principles of the present disclosure should be included within the scope of the present disclosure.

1. A charging device, comprising:
a base, comprising a seat body and a first arm protruding from the seat body along a first direction; wherein the first arm is arranged with a first rotatable portion extending along a second direction, and the first direction and the second direction are set at an angle;
a rotatable body; wherein the first rotatable portion penetrates the rotatable body and is rotatably connected to the rotatable body, and the rotatable body is configured to support an external device and adjust an angle of the charging device; and
a hover assembly, configured to enable the rotatable body to support the external device to hover at a preset angle.

2. The charging device according to claim 1, wherein the hover assembly is disposed between the rotatable body and the first rotatable portion.

3. The charging device according to claim 1, wherein the hover assembly comprises:
a first connecting member, fixedly connected to the first rotatable portion;
a second connecting member, fixedly connected to the rotatable body; wherein the first connecting member and the second connecting member are rotatably connected and have a damping cooperation; and
an adjusting member, connected to both the first connecting member and the second connecting member; wherein the adjusting member is configured to adjust torque between the first connecting member and the second connecting member.

4. The charging device according to claim 1, wherein the hover assembly comprises:
a first pressing buckle, fixedly connected to the first rotatable portion; and
a first bearing, fixedly connected to the rotatable body; wherein the first bearing is sleeved on the first pressing buckle and is rotatably connected to the first pressing buckle.

5. The charging device according to claim 1, further comprising:
a second arm, protruding from the seat body along a third direction; wherein the second arm is spaced apart from the first arm, and the second arm extends along a fourth direction to form a second rotatable portion; the second rotatable portion penetrates an outer wall of the rotatable body; the rotatable body is disposed between the first rotatable portion and the second rotatable portion and is hingedly connected to both the first rotatable portion and the second rotatable portion; wherein the fourth direction is opposite to the second direction.

6. The charging device according to claim 5, wherein the rotatable body defines a first rotating hole and a second rotating hole that are coaxial; the first rotatable portion is rotatably disposed in the first rotating hole, and the second rotatable portion is rotatably disposed in the second rotating hole.

7. The charging device according to claim 6, wherein at least one of the following is satisfied:
one of the first rotatable portion and a hole wall of the first rotating hole is arranged with a first limiting protrusion, and the other of the first rotatable portion and the hole wall of the first rotating hole defines a first limiting groove; the first limiting protrusion is slidably disposed in the first limiting groove, and the first limiting protrusion and the first limiting groove cooperate to limit a rotation angle of the rotatable body relative to the first arm; and
one of the second rotatable portion and a hole wall of the second rotating hole is arranged with a second limiting protrusion, and the other of the second rotatable portion and the hole wall of the second rotating hole defines a second limiting groove; the second limiting protrusion is slidably disposed in the second limiting groove, and the second limiting protrusion and the second limiting groove cooperate to limit a rotation angle of the rotatable body relative to the second arm.

8. The charging device according to claim 7, wherein at least one of the following is satisfied:
in a rotation direction of the rotatable body, the first limiting protrusion abuts against both side walls of the first limiting groove to restrict rotation of the rotatable body, and a difference in size between the first limiting protrusion and the first limiting groove in the rotation direction of the rotatable body defines a rotation range of the rotatable body; and
in a rotation direction of the rotatable body, the second limiting protrusion abuts against both side walls of the second limiting groove to restrict rotation of the rotatable body, and a difference in size between the second limiting protrusion and the second limiting groove in the rotation direction of the rotatable body defines the rotation range of the rotatable body.

9. The charging device according to claim 6, wherein a hole wall of the second rotating hole is arranged with a second limiting protrusion, and the charging device further comprises:
a second pressing buckle; wherein an end of the second pressing buckle is fixedly connected to the second rotatable portion, and another end of the second pressing buckle passes through the second rotating hole and is arranged with a flange; and
a second bearing, fixedly connected to the rotatable body; wherein the second bearing is sleeved on the second pressing buckle and is rotatably connected to the second pressing buckle, the second pressing buckle is disposed between the flange and the second limiting protrusion, and the flange and the second limiting protrusion jointly limit the second pressing buckle.

10. The charging device according to claim 1, wherein the first arm is hingedly connected to the seat body, and a rotation axis of the first arm is set at an angle to a rotation axis of the rotatable body.

11. The charging device according to claim 1, further comprising:
a wireless charging module, disposed on the rotatable body and configured to wirelessly charge the external device; and
a light-emitting module, disposed inside the rotatable body.

12. The charging device according to claim 11, wherein the wireless charging module comprises:
a coil;
a main control board, electrically connected to the coil;
a magnetic isolation sheet, disposed between the main control board and the coil; and
a magnet, surrounding the coil.

13. The charging device according to claim 5, wherein the seat body internally defines a first mounting cavity, and the second arm internally defines a first wire channel communicating with the first mounting cavity; the rotatable body internally defines a second mounting cavity, and the second rotatable portion internally defines a second wire channel communicating with the first wire channel and the second mounting cavity.

14. The charging device according to claim 11, wherein the rotatable body has a first end and a second end that are opposite to each other; the wireless charging module is disposed on the first end, and the light-emitting module is disposed on the second end.

15. The charging device according to claim 14, wherein the rotatable body further comprises a light-transmitting cover disposed on the second end, and the light-emitting module is spaced apart from the light-transmitting cover.

16. The charging device according to claim 14, further comprising:
an operation module, disposed on the seat body and electrically connected to the light-emitting module; wherein the operation module is configured to adjust at least one of a color temperature and a brightness of the light-emitting module.

17. The charging device according to claim 14, further comprising at least one of:
a rechargeable battery, disposed in the rotatable body or the seat body; wherein the rechargeable battery is electrically connected to both the wireless charging module and the light-emitting module to supply power to the wireless charging module and the light-emitting module; and
a connecting terminal, disposed on the seat body; wherein the connecting terminal is electrically connected to both the wireless charging module and the light-emitting module to supply power to the wireless charging module and the light-emitting module.

18. A charging device, comprising:
a base;
a rotatable body, disposed on the base and rotatably connected to the base; wherein the rotatable body is configured to support an external device and adjust an angle of the charging device;
a wireless charging module, disposed on the rotatable body and configured to wirelessly charge the external device; and
a light-emitting module, disposed inside the rotatable body; wherein a light-transmitting portion is arranged on the rotatable body at a position corresponding to the light-emitting module.

19. The charging device according to claim 18, wherein the charging device further comprises an operation module disposed on the base and electrically connected to the light-emitting module; wherein the operation module is configured to adjust at least one of: color temperature of the light-emitting module and brightness of the light-emitting module.

20. A charging device, comprising:
a base, comprising an upper seat, a lower seat, and a first support arm; wherein the upper seat is disposed on the lower seat, and the first support arm is disposed on the upper seat;
a rotatable body, rotatably connected to the first support arm around a first axis; wherein the rotatable body is configured to support an external device and adjust an angle of the charging device;
a wireless charging module, disposed on the rotatable body; and
a light-emitting module, disposed on the rotatable body;
wherein at least one of the following is satisfied:
the first support arm is rotatably connected to the upper seat around a second axis, and the second axis is arranged at an angle to the first axis; and
the upper seat is rotatably connected to the lower seat around a third axis, and the third axis is arranged at an angle to the first axis.
